(19) United States
(12) Patent Application Publication
(10) Pub. No.: US 2026/0122354 A1
(43) Pub. Date: Apr. 30, 2026

(54) IMAGE CAPTURING APPARATUS, INFORMATION PROCESSING APPARATUS, IMAGE CAPTURING METHOD, AND STORAGE MEDIUM

(71) Applicant: CANON KABUSHIKI KAISHA, Tokyo (JP)

(72) Inventor: TAKUMA JIKO, Kanagawa (JP)

(21) Appl. No.: 19/351,651

(22) Filed: Oct. 7, 2025

(30) Foreign Application Priority Data
Oct. 24, 2024 (JP) 2024-187730

(51) Int. Cl. H04N 23/69; H04N 23/663; H04N 23/695

(52) U.S. Cl. CPC H04N 23/69; H04N 23/695; H04N 23/663

(57) ABSTRACT

An image capturing apparatus comprises an image capturing unit configured to capture an image via a lens, an image capturing direction control unit configured to control an image capturing direction of the image capturing unit, a preset information management unit configured to, when registering a preset of the image capturing direction, create a thumbnail based on an image captured by the image capturing unit, and store, as preset setting information, the thumbnail, the image capturing direction, and focal length information of the lens, by associating the thumbnail, the image capturing direction, and the focal length information, and a control unit configured to, in a case in which the lens is replaced, perform update of the focal length information in the preset setting information according to a focal length drive range of a newly mounted lens.

### BACKGROUND

### Field

The present disclosure relates to an image capturing apparatus, an information processing apparatus, an image capturing method, a storage medium, and the like.

### Description of the Related Art

Pan-tilt-zoom (PTZ) cameras have a function that recalls PTZ to a desired position quickly by setting the position of PTZ in advance. This function is called a preset function. For example, Japanese Patent Application Laid-Open No. 2008-22260 describes a configuration that, by displaying an image at the time of preset registration as a thumbnail image for the preset function, makes the angle of view of the registered preset recognizable to a user at a glance.

However, in interchangeable lens PTZ cameras, there are cases in which the lens after replacement cannot reproduce the focal length at the time of preset registration. In such cases, because the angle of view at the time of preset registration displayed in the thumbnail differs from the angle of view at the time of preset execution, there is a problem in that the user inadvertently performs execution of the preset at an unintended angle of view.

### SUMMARY

An image capturing apparatus according to an embodiment of the present disclosure comprises an image capturing unit configured to capture an image via a lens, an image capturing direction control unit configured to control an image capturing direction of the image capturing unit, a preset information management unit configured to, when registering a preset of the image capturing direction, create a thumbnail based on an image captured by the image capturing unit, and store, as preset setting information, the thumbnail, the image capturing direction, and focal length information of the lens, by associating the thumbnail, the image capturing direction, and the focal length information, and a control unit configured to, in a case in which the lens is replaced, perform update of the focal length information in the preset setting information according to a focal length drive range of a newly mounted lens.

Further features of the present disclosure will become apparent from the following description of embodiments with reference to the attached drawings.

### BRIEF DESCRIPTION OF THE DRAWINGS

FIG. 1 is a functional block diagram showing a configuration example of an image capturing apparatus of a First Embodiment.

FIG. 2 is a diagram showing an example of an operation screen of the image capturing apparatus before preset registration of the First Embodiment.

FIG. 3 is a flowchart showing a processing example of preset registration of the First Embodiment.

FIG. 4 is a diagram showing an example of an operation screen of the image capturing apparatus after preset registration of the First Embodiment.

FIG. 5 is a flowchart showing a processing example of preset recall of the First Embodiment.

FIG. 6 is a diagram showing an example of an operation screen of the image capturing apparatus before lens replacement of the First Embodiment.

FIG. 7 is a flowchart showing an example of update processing of preset information of the First Embodiment.

FIG. 8 is a diagram showing an example of an operation screen of the image capturing apparatus after lens replacement in the First Embodiment in a case in which the image capturing apparatus is driven to the limit.

FIG. 9 is a diagram showing an example of an operation screen of the image capturing apparatus after lens replacement in the First Embodiment in a case in which execution of the preset is prohibited.

FIG. 10 is a functional block diagram showing a configuration example of an image capturing apparatus of a Second Embodiment.

FIG. 11 is a diagram showing an example of an operation screen of the image capturing apparatus before preset registration of the Second Embodiment.

FIG. 12 is a flowchart showing a processing example of preset registration of the Second Embodiment.

FIG. 13 is a diagram showing an example of an operation screen of the image capturing apparatus after preset registration of the Second Embodiment.

FIG. 14 is a flowchart showing a processing example of preset recall of the Second Embodiment.

FIG. 15 is a diagram showing an example of an operation screen of the image capturing apparatus before lens replacement in the Second Embodiment.

FIG. 16A is a flowchart showing a processing example of update processing of preset information of the Second Embodiment.

FIG. 16B is a flowchart that is a continuation of FIG. 16A.

FIG. 17 is a diagram for explaining a relationship among focal length, sensor size, and angle of view.

FIG. 18 is a diagram showing an example of an operation screen of the image capturing apparatus after lens replacement of the Second Embodiment.

FIG. 19 is a functional block diagram showing a configuration example of an information processing apparatus of a Third Embodiment.

FIG. 20 is a flowchart showing a processing example of preset registration of the Third Embodiment.

FIG. 21 is a flowchart showing a processing example of preset recall of the Third Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

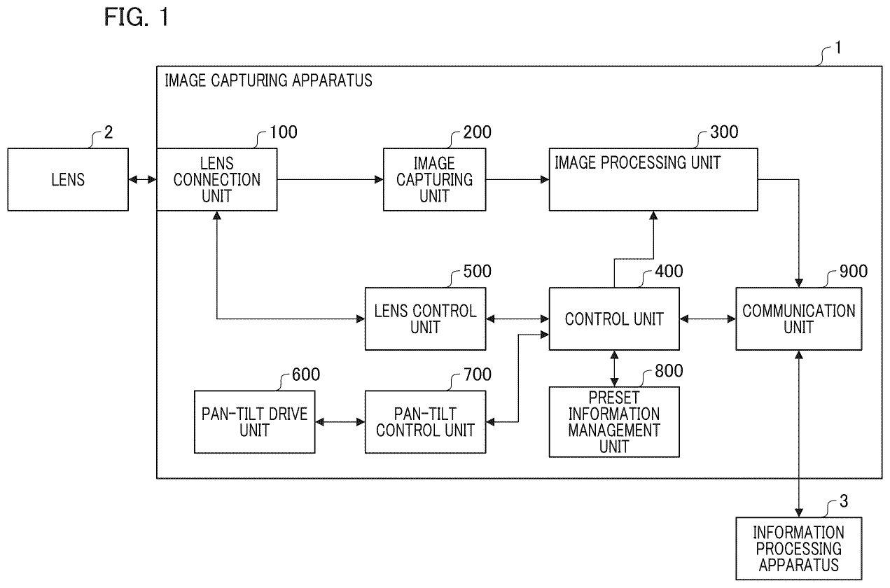

FIG. 1 is a functional block diagram showing a configuration example of an image capturing apparatus of a First Embodiment. It should be noted that a part of the functional blocks shown in FIG. 1 is realized by causing a CPU or the like serving as a computer (not shown) included in a control unit 400 of the image capturing apparatus to execute a computer program stored in a memory serving as a storage medium (not shown).

However, a part or all of the functional blocks may be realized by hardware. As hardware, a dedicated circuit (ASIC), a processor (reconfigurable processor, DSP), and the like can be used.

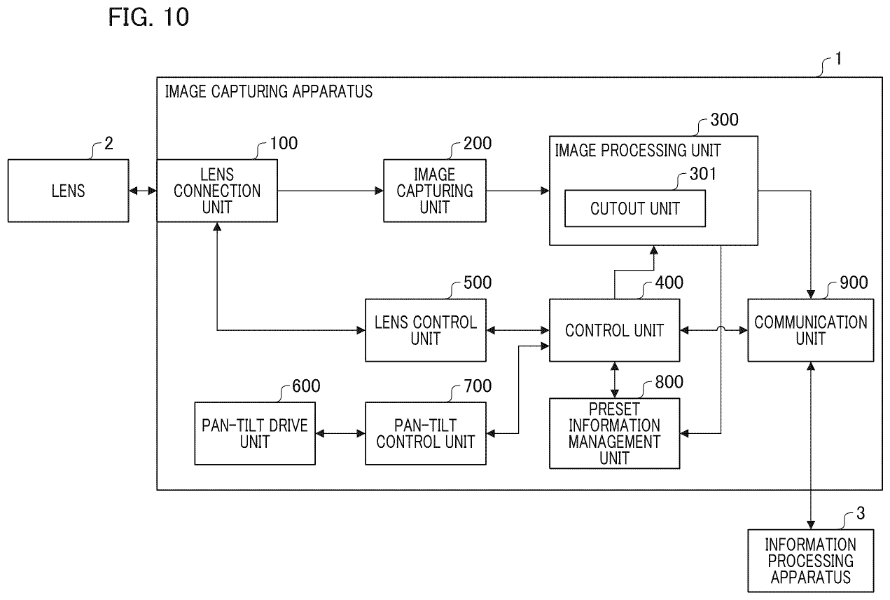

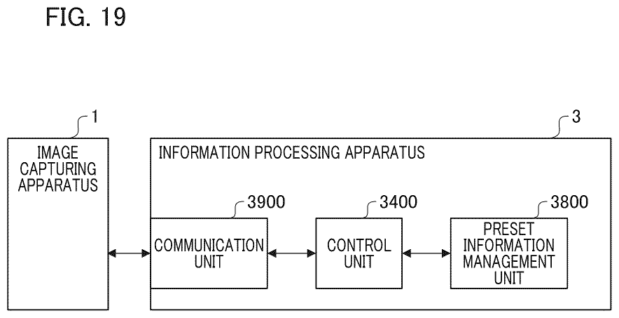

In addition, the respective functional blocks shown in FIG. 1 do not have to be built into the same housing, and the respective functional blocks may be configured by separate apparatuses connected to each other via signal paths. It should be noted that the above explanation regarding FIG. 1 similarly applies to FIG. 10 and FIG. 19.

An image capturing apparatus 1 of the present embodiment is set on a pan-tilt platform (not shown), and pan, tilt, and zoom (hereinafter, PTZ) is possible. In addition, the image capturing apparatus 1 can removably mount a lens 2. It should be noted that the image capturing apparatus 1 may include the lens 2.

The image capturing apparatus 1 comprises a lens connection unit 100, an image capturing unit 200, an image processing unit 300, the control unit 400, a lens control unit 500, a pan-tilt drive unit 600, a pan-tilt control unit 700, a preset information management unit 800, and a communication unit 900.

The lens connection unit 100 can connect the lens 2 and the image capturing apparatus 1 via, for example, electrical contact points, and the image capturing apparatus 1 and the lens 2 perform communication with each other via the lens connection unit 100. In the communication, a drive command for zoom or focus is transmitted to the lens 2, and data are transmitted and received, the data including an operation state inside the image capturing apparatus 1 or the lens 2, and optical information of the lens stored in a ROM or the like in the lens. It should be noted that communication between the lens 2 and the image capturing apparatus 1 may be wireless communication, or may be communication using light.

The image capturing unit 200 is an image capturing element such as a CCD (Charge Coupled Device) or a CMOS (Complementary Metal Oxide Semiconductor) sensor, and is an image capturing sensor that converts an image of light captured via the lens 2 into an image capturing signal. It should be noted that the image capturing unit 200 captures images via a lens.

The image processing unit 300 is an image processing circuit configured to perform various image processing on electrical signals converted by the image capturing unit 200, and converts the electrical signals into video signals. The control unit 400 is a control unit configured to perform various controls of the image capturing apparatus 1, and a CPU or the like serving as a computer is built in the control unit 400, and the control unit 400 functions as a control unit for controlling operations of respective units of the entire apparatus based on a computer program stored in a memory serving as a storage medium.

The lens control unit 500 performs drive control of the lens 2, performs drive commands of zoom or focus to the lens 2 according to control of the control unit 400, and controls drive of the lens 2. The pan-tilt drive unit 600 is a drive unit that rotates the image capturing apparatus 1 in a pan direction and a tilt direction, and can change an image capturing direction of the image capturing apparatus 1.

In addition, the pan-tilt drive unit 600 is provided with a motor for pan rotation and a motor for tilt rotation, and performs rotation drive by rotating the motors. Furthermore, the respective motors are provided with encoders such as pulse encoders, and rotation positions of the motors can be detected. It should be noted that although the present embodiment is provided with both the motor for pan rotation and the motor for tilt rotation, the pan-tilt drive unit 600 need only have at least one of the motor for pan rotation and the motor for tilt rotation.

The pan-tilt control unit 700 controls drive of the image capturing apparatus 1 in pan-tilt directions, and performs pan-tilt drive commands according to control of the control unit 400, and controls drive of the pan-tilt drive unit 600.

It should be noted that the pan-tilt control unit 700 functions as an image capturing direction control unit that executes an image capturing direction control step for controlling an image capturing direction of an image capturing unit that captures an image via the lens. In addition, although the pan-tilt control unit 700 in the present embodiment can control both pan and tilt, the image capturing direction control unit need only control at least one of a pan direction and a tilt direction.

The preset information management unit 800 manages by associating preset position information that records combinations of position information (angle information) of pan and position information (angle information) of tilt, zoom information (focal length information), image cutout information, and the like, and thumbnails created from video at the time of preset registration.

When registering the image capturing direction as a preset, the preset information management unit 800 creates a thumbnail based on an image captured by the image capturing unit, and stores preset setting information by associating (linking) the thumbnail, the image capturing direction, and the focal length information of the lens together.

The communication unit 900 is a communication interface for performing communication with an external information processing apparatus 3 or other equipment for controlling the image capturing apparatus 1 from outside.

First, processing from an image of light taken in via the lens 2 to creation of a video signal is explained. The image of light formed by the lens 2 is photoelectrically converted in the image capturing unit 200.

The image processing unit 300 generates a video signal by performing various image processing and image correction on the photoelectrically converted image capturing signals. The generated video signal is output to equipment such as the external information processing apparatus 3 via the communication unit 900. In addition, recording to a recording medium such as an SD card is performed by a recording unit (not shown).

Next, pan-tilt-zoom operations of the image capturing apparatus 1 are explained. Pan-tilt-zoom control commands from a user received from the external information processing apparatus 3 for controlling the image capturing apparatus 1 are transmitted to the control unit 400 by the communication unit 900.

It should be noted that the external information processing apparatus 3 has a CPU serving as a computer and a memory serving as a storage medium, and the information processing apparatus 3 performs control of the entire information processing apparatus 3 by causing the CPU inside the information processing apparatus 3 to execute a computer program stored in the memory. In addition, the information processing apparatus 3 has a video display capable of displaying video.

The control unit 400 generates pan-tilt drive commands according to the pan-tilt-zoom control commands, and transmits the pan-tilt drive commands to the pan-tilt control unit 700. The pan-tilt control unit 700 drives the pan-tilt drive unit 600 according to the pan-tilt drive commands, thereby executing pan-tilt drive designated by the user.

In addition, commands regarding zoom drive are transmitted to the lens control unit 500, and drive commands of the lens control unit 500 are transmitted to the lens 2 via the lens connection unit 100, whereby zoom drive of the lens 2 is performed and zoom drive designated by the user is executed.

Next, processing of the preset function is explained. The preset function is a function that registers an image capturing direction (pan direction, tilt direction) and zoom position of an image capturing apparatus (camera) in advance, and reproduces an angle of view at the time of preset registration by reading out the registered preset position.

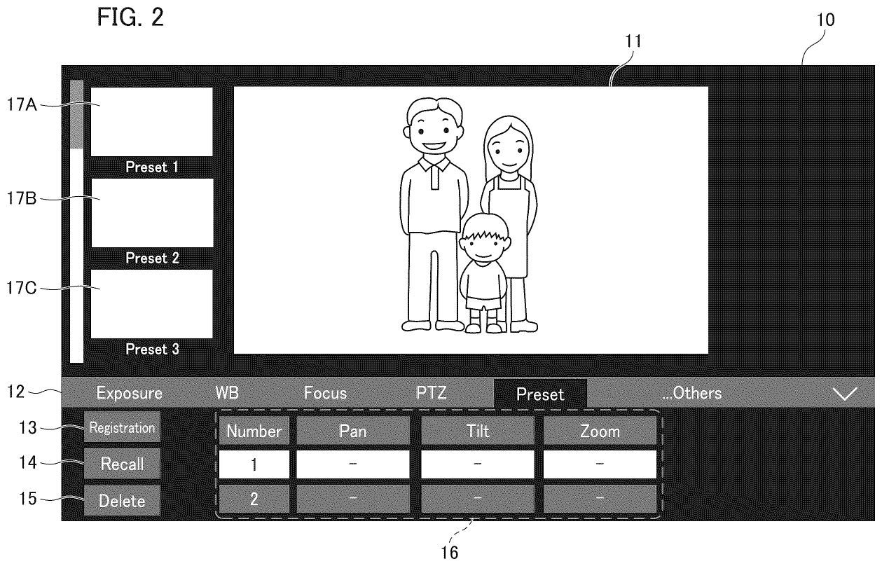

FIG. 2 is a diagram showing an example of an operation screen of an image capturing apparatus before preset registration of the First Embodiment. In the present embodiment, an operation screen 10 is generated inside the image capturing apparatus 1, transmitted to an external information processing apparatus 3 via the communication unit 900, and displayed on a video display of the information processing apparatus. However, the operation screen 10 may be generated in the information processing apparatus 3.

The operation screen 10 comprises a video display unit 11, a menu unit 12, a preset registration button 13, a preset recall button 14, a preset deletion button 15, a preset information display unit 16, and thumbnail display units 17A to 17C.

The video display unit 11 is a display unit configured to display video that has been image-processed by the image processing unit 300. The menu unit 12 is a menu unit that performs display/setting of setting items of various functions of the image capturing apparatus 1. It should be noted that FIG. 2 shows a screen when “preset”, which is a menu related to a preset function, is selected.

The preset registration button 13 is a button that initiates preset registration processing for an arbitrary preset number. The preset recall button 14 is a button that initiates recall processing of a preset registered to an arbitrary preset number. The preset deletion button 15 is a button for performing deletion of preset information registered to an arbitrary preset number.

The preset information display unit 16 is a display unit that displays preset information registered to each preset number. Pan-tilt drive positions from a reference position, focal length information of the lens, and the like are displayed in the preset information display unit 16. The thumbnail display units 17A to 17C are display units that display thumbnail images based on images captured at the time of preset registration.

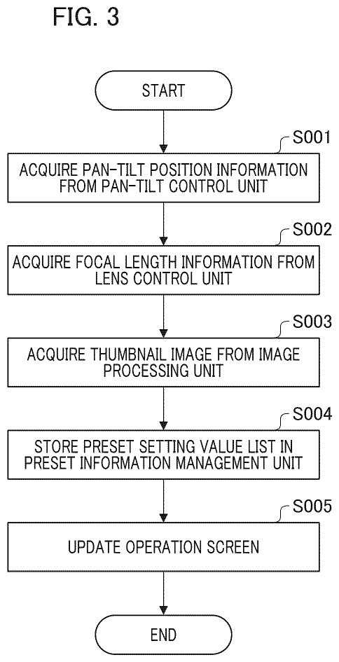

FIG. 3 is a flowchart showing a processing example of preset registration of the First Embodiment, and next, processing at the time of preset registration is explained. It should be noted that operations of the respective steps of the flowchart of FIG. 3 are performed sequentially by causing a CPU or the like serving as a computer in the control unit 400 to execute a computer program stored in a memory.

When the preset registration button 13 of FIG. 2 is pressed, a preset registration process is started in accordance with the flow shown in FIG. 3. When the preset registration button 13 is pressed and preset registration processing is initiated, in step S001, the control unit 400 issues a pan-tilt position information acquisition request to the pan-tilt control unit 700, and acquires pan-tilt position information (angle information) from the pan-tilt control unit 700.

When the pan-tilt control unit 700 receives a position information acquisition request from the control unit 400, the pan-tilt control unit 700 acquires encoder values of the pan-tilt drive unit 600, converts the encoder values to pan-tilt position information (angle information), and transmits the pan-tilt position information to the control unit 400 as a response to the pan-tilt position information acquisition request. That is, in step S001, the image capturing direction of the image capturing unit that captures an image via the lens is acquired.

Next, in step S002, focal length information is acquired from the lens control unit 500. That is, the control unit 400 issues a focal length information acquisition request to the lens control unit 500, and when the lens control unit 500 receives the focal length information acquisition request from the control unit 400, the lens control unit 500 acquires the internal operation state of the current lens 2 via the lens connection unit 100.

Focal length information is created from the acquired operation state, and a response to the focal length information acquisition request is returned to the control unit 400. That is, in step S002, focal length information of the lens is acquired.

Next, in step S003, a thumbnail image is acquired from the image processing unit. That is, the control unit 400 issues a thumbnail image acquisition request to the image processing unit 300, and when the image processing unit 300 receives the thumbnail image acquisition request from the control unit 400, the image processing unit 300 creates a thumbnail image from a video signal, and returns a response to the thumbnail image acquisition request to the control unit 400. That is, in step S003, a thumbnail based on an image captured by the image capturing unit 200 is created.

Next, in step S004, a preset setting value list is stored in the preset information management unit. That is, the control unit 400 creates a preset setting value list from information acquired in step S001 to step S003, and stores the preset setting value list in the preset information management unit 800.

Here, step S001 to step S004 function as a preset information management step. In addition, in the preset information management step, when registering an image capturing direction as a preset, a thumbnail based on an image captured by an image capturing unit is created, and the thumbnail, the image capturing direction, and the focal length information of the lens are associated (linked) together and stored as preset setting information.

Next, in step S005, the operation screen is updated. That is, the operation screen is transmitted to the information processing apparatus 3, and the preset information display unit 16 and the thumbnail display unit 17 of the operation screen of the image capturing apparatus 1 are updated.

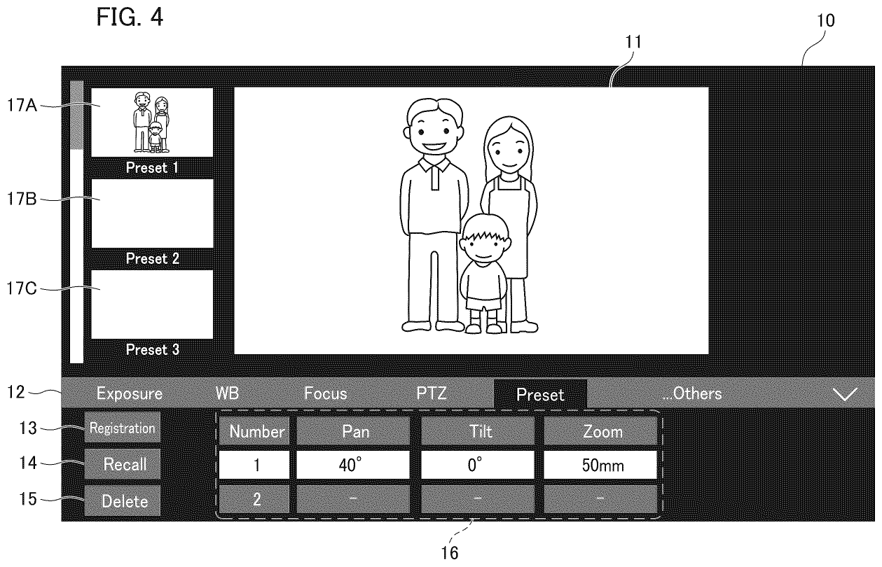

FIG. 4 is a diagram showing an example of an operation screen of an image capturing apparatus after preset registration of the First Embodiment. In the operation screen of the image capturing apparatus 1 after updating, as shown in FIG. 4, the preset information stored in the preset setting value list is displayed in the preset information display unit 16, and the thumbnail image created in step S003 is displayed in the thumbnail display unit 17. When update of the operation screen is completed, registration processing of the preset is ended.

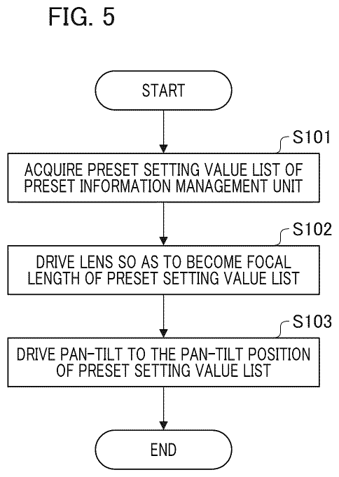

FIG. 5 is a flowchart showing a processing example of preset recall of the First Embodiment. It should be noted that operations of each step of the flowchart of FIG. 5 are performed sequentially by causing a CPU or the like serving as a computer in the control unit 400 to execute a computer program stored in a memory.

When the preset recall button 14 of FIG. 2 is pressed, preset recall processing is started in accordance with the flow shown in FIG. 5. When the preset recall button 14 is pressed and preset recall processing is started, in step S101, the preset setting value list of the preset information management unit is acquired. That is, the control unit 400 acquires the preset setting value list corresponding to the preset number to be recalled from the preset information management unit 800.

Next, in step S102, the lens is driven so that the focal length becomes the focal length of the preset setting value list. That is, the control unit 400 issues a focal length drive request command to the lens control unit 500 so that the lens focal length becomes the lens focal length indicated in the preset setting value list acquired in step S101.

Then, when the lens control unit 500 receives the focal length drive command from the control unit 400, the lens control unit 500 drives the focal length of the lens 2 via the lens connection unit 100 so that the focal length becomes the commanded focal length.

Next, in step S103, pan-tilt drive is performed so that the pan-tilt position becomes the position of the preset setting value list. That is, the control unit 400 issues a pan-tilt drive request command to the pan-tilt control unit 700 so that the pan-tilt position becomes the pan-tilt position indicated by the pan-tilt position information (angle information) in the preset setting value list acquired in step S101.

Then, when the pan-tilt control unit 700 receives the pan-tilt drive request command from the control unit 400, the pan-tilt control unit 700 drives the pan-tilt drive unit 600 so that the pan-tilt position becomes the commanded pan-tilt position. Thereafter, the preset recall processing flow of FIG. 5 is ended. By controlling as described above, the preset-registered angle of view can be reproduced.

Next, preset deletion processing is explained. When the preset deletion button 15 of FIG. 2 is pressed, preset deletion processing is started. That is, the control unit 400 deletes the preset setting value list corresponding to the preset number to be deleted from the preset information management unit 800.

Next, updating of the operation screen of FIG. 2 is performed by performing deletion of the preset information of the preset information display unit 16 and the thumbnail image of the thumbnail display unit 17 corresponding to the deleted preset number. When updating of the operation screen is completed, preset deletion processing is ended.

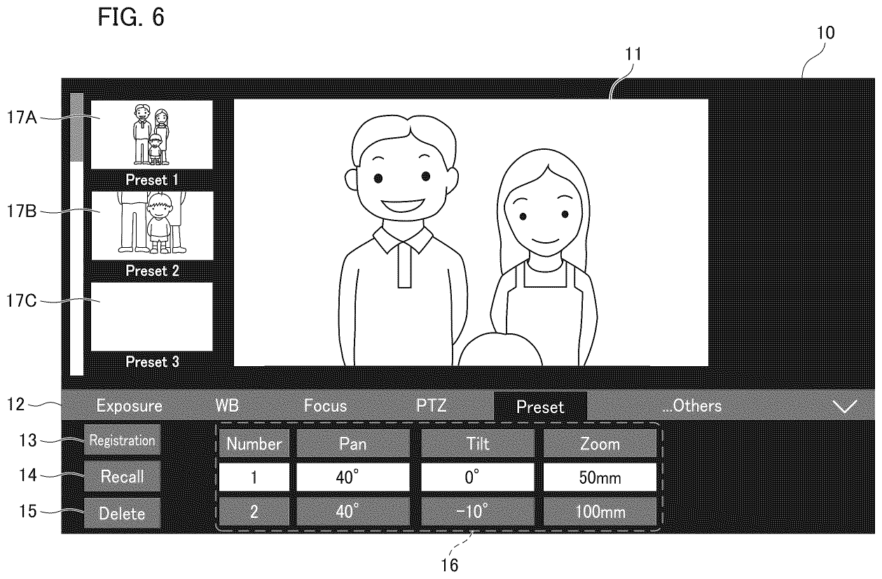

Next, processing at the time of lens replacement is explained by using FIG. 6. FIG. 6 is a diagram showing an example of an operation screen of an image capturing apparatus before lens replacement of the First Embodiment. In FIG. 6, processing is explained for a case in which, after preset registration using a lens having a focal length of 24 mm to 105 mm, the lens is replaced with a lens having a focal length of 24 mm to 70 mm.

In FIG. 6, as described above, in a state before lens replacement, a lens having a focal length of 24 mm to 105 mm is mounted on the image capturing apparatus 1, and preset registration is performed for preset number 1 and preset number 2. For preset number 1, a pan position of 40°, a tilt position of 0°, a zoom of 50 mm, and a thumbnail image displayed in the thumbnail display unit 17A are associated (linked) and registered as a preset.

In contrast, in preset number 2, a pan position of 40°, a tilt position of −10°, a zoom of 100 mm, and a thumbnail image displayed in the thumbnail display unit 17B are associated (linked) and are registered as a preset.

In such a state, a case in which a lens having a focal length of 24 mm to 105 mm that is mounted is removed from the image capturing apparatus and instead replaced with a lens having a focal length of 24 mm to 70 mm is assumed. In this case, a zoom focal length that is registered as a preset for preset number 2 cannot be realized by the lens after replacement.

Accordingly, in the present embodiment, at the time of lens replacement, settings for the processing to be performed in a case in which a focal length of a preset cannot be realized are prepared in advance, and at the time of lens replacement, processing is performed according to the setting values. It should be noted that although the present embodiment explains a case in which there are two choices as processing options when a focal length cannot be realized, and, as an example, the choices comprise “drive to the drive limit” and “do not operate”, the present embodiment may have other options.

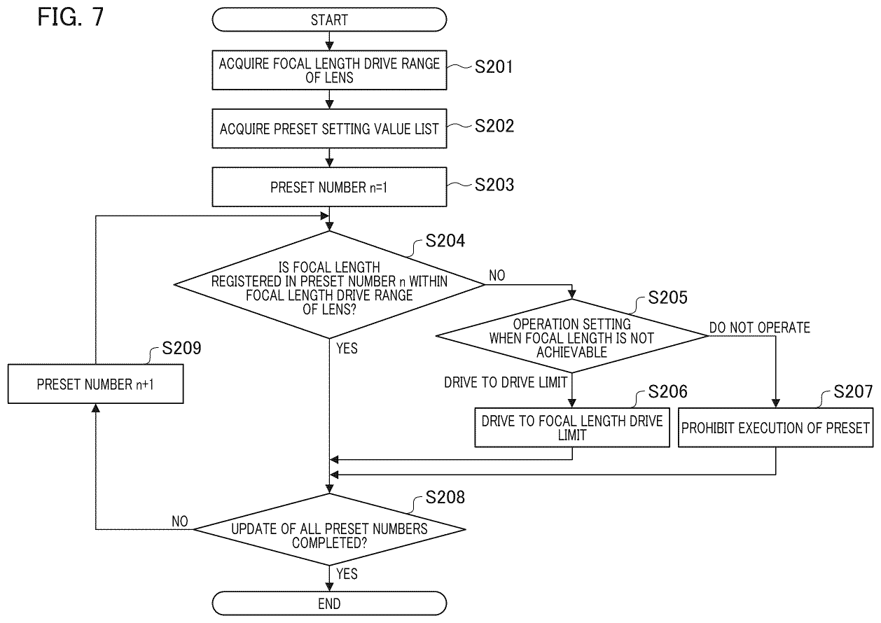

FIG. 7 is a flowchart showing an example of update processing of preset information of the First Embodiment. It should be noted that operations of each step of the flowchart of FIG. 7 are performed sequentially by causing a CPU or the like serving as a computer in the control unit 400 to execute a computer program stored in a memory.

When lens replacement is performed, update processing of preset information is initiated according to the flow shown in FIG. 7. When the lens is replaced, in step S201, the focal length drive range of the lens is acquired. That is, the lens control unit 500 detects that the lens 2 has been replaced and connected via the lens connection unit 100, and outputs lens connection detection information to the control unit 400.

When the control unit 400 receives lens connection detection information, the control unit 400 issues a lens focal length drive range information acquisition request to the lens control unit 500. When the lens control unit 500 receives the lens focal length drive range information acquisition request, the lens control unit 500 performs communication with the lens 2 via the lens connection unit 100, and acquires a focal length drive range of the lens that is stored in advance in a ROM in the mounted lens 2. Then, the lens control unit 500 returns the acquired focal length drive range information to the control unit 400.

Next, in step S202, the control unit 400 acquires the preset setting value list stored in the preset information management unit 800.

In step S203, 1 is set to a preset number n that becomes a target of update processing of preset information. In step S204, a determination is made as to whether or not a focal length registered in the preset number n is within a focal length drive range of the mounted lens.

That is, the control unit 400 acquires focal length information Fn of the lens registered in the preset number n of the preset setting value list acquired in step S202. Based on focal length drive range information of the mounted lens 2 acquired in step S201, a focal length Fmin at the wide-angle end of the lens 2 and a focal length Fmax at the telephoto end of the lens 2 are acquired. In a case in which an inequality of Fmin<=Fn<=Fmax is established, Yes is determined in step S204, and the processing proceeds to step S208. In contrast, in a case in which the inequality is not established, the processing proceeds to step S205.

Next, in step S205, in a case in which operation setting when a focal length cannot be realized is set to “drive to the drive limit”, the processing proceeds to step S206, and in a case in which the operation setting is set to “do not operate”, the processing proceeds to step S207.

In step S206, the focal length is driven to the drive limit. That is, for example, in a case in which Fn<Fmin, the control unit 400 updates focal length information Fn of the lens registered in the preset number n to Fmin.

Similarly, in a case in which Fmax<Fn, in step S206, the control unit 400 updates focal length information Fn of the lens registered in the preset number n to Fmax. When the update of focal length information of the preset number n is completed, the processing proceeds to step S208.

Here, step S204 to step S207 function as control steps in which the updating of the focal length information in the preset setting information is performed according to the focal length drive range of the newly mounted lens in a case in which the lens is replaced.

It should be noted that because an angle of view represented by the thumbnail of the preset number n differs from an angle of view after preset execution at this time, update of the thumbnail (for example, enlargement or reduction of thumbnail images, and the like) may be performed based on focal length information Fn updated in step S206.

In addition, because an angle of view different from the angle of view at the time of preset registration occurs due to change of focal length information, predetermined identification information (for example, text such as “angle of view has changed” or a predetermined icon, and the like) may be displayed to notify the user of a change in the angle of view from the angle of view at the time of preset registration.

In contrast, in step S207, preset execution of the preset number n is set to a prohibited state, and the preset number n is set to a state in which the preset is not executed even in a case in which preset recall of the preset number n is performed, and the processing proceeds to step S208.

In this manner, in the present embodiment, in a case in which an angle of view registered by preset registration is unrealizable by a focal length of a newly mounted lens and unrealizable even when image cutout processing is used in combination, execution of the preset is restricted.

In step S208, a determination is made as to whether or not update processing for all preset numbers n registered as presets has been completed, and in a case in which the update processing has been completed, the update processing flow of preset information of FIG. 7 is ended. In a case in which No is determined in step S208, the processing proceeds to step S209.

In step S209, after incrementing the preset number n that becomes a target of update processing of preset information, the processing proceeds to step S204, and thereafter, the processing described above is repeated.

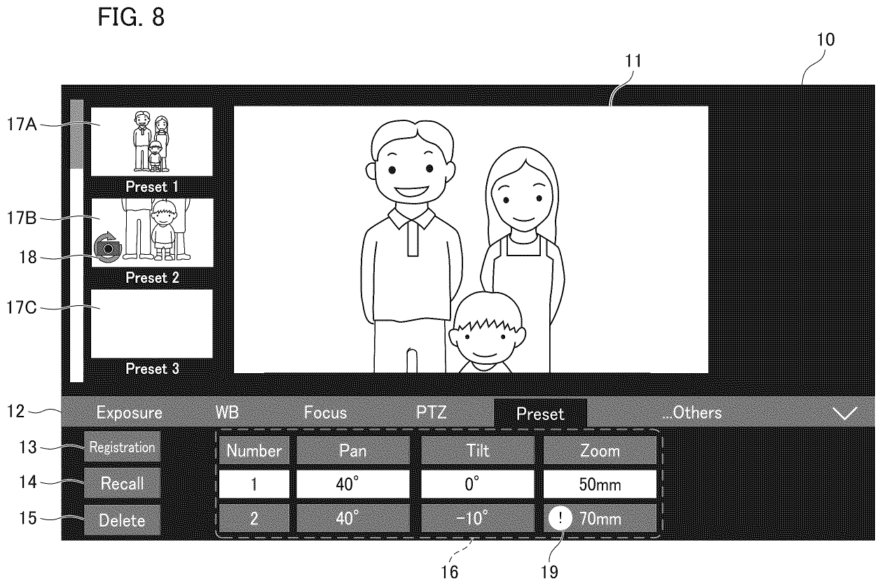

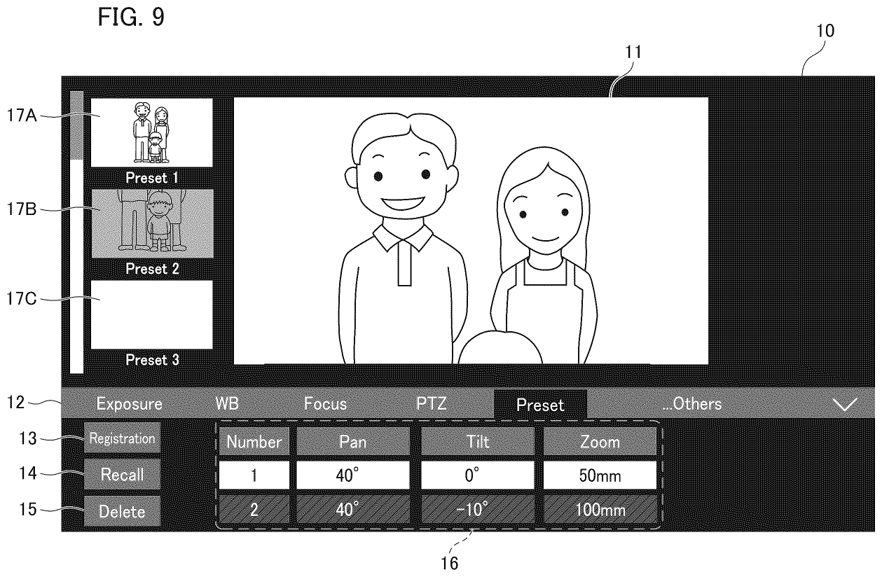

When the update processing flow of preset information in FIG. 7 as described above is completed, the operation screen of the image capturing apparatus is updated, according to the operation setting when a focal length cannot be realized, to an operation screen as shown in FIG. 8 or FIG. 9.

FIG. 8 is a diagram showing an example of an operation screen of the image capturing apparatus after lens replacement in a case in which driving to the limit is performed in the First Embodiment, and FIG. 9 is a diagram showing an example of an operation screen of the image capturing apparatus after lens replacement in a case in which execution of the preset is prohibited in the First Embodiment.

In a case in which operation setting when a focal length cannot be realized is “drive to the drive limit”, the screen is updated to an operation screen of an image capturing apparatus as shown in FIG. 8. Main changes from FIG. 6 are that focal length information registered in “zoom” of preset number 2 of the preset information display unit 16 is updated and that the thumbnail of the thumbnail display unit 17B of preset number 2 is updated.

In addition, a thumbnail update icon 18 is displayed to notify the user that the thumbnail of the thumbnail display unit 17B has been updated and that the angle of view is different from the angle of view at the time of preset registration.

In addition, a zoom update icon 19 is displayed to notify the user that the focal length information registered in “zoom” of preset number 2 of the preset information display unit 16 has been updated and that the angle of view is different from the angle of view at the time of preset registration.

In a case in which operation setting when a focal length cannot be realized is “do not operate”, the screen is updated to an operation screen of the image capturing apparatus as shown in FIG. 9. The change from FIG. 6 is that the preset information corresponding to preset number 2 in the preset information display unit 16, and the thumbnail corresponding to preset number 2 in the thumbnail display unit 17B, are grayed out and made unselectable.

In contrast, because preset content registered in preset number 1 is realizable even after lens replacement, preset information in FIG. 8 and FIG. 9 is the same as preset information of FIG. 6, and thumbnails in FIG. 8 and FIG. 9 are also the same as thumbnails of FIG. 6. In addition, in both operation screens of FIG. 8 and FIG. 9, preset recall is possible as before lens replacement, and the same angle of view can be realized before and after lens replacement.

In the present embodiment, by performing processing as explained above, an angle of view at the time of preset registration can be reproduced even for presets registered using different lenses.

### Second Embodiment

Hereinafter, a Second Embodiment of the present disclosure is explained. In the preset function explained in the First Embodiment, the pan-tilt position information (angle information), the focal length of the lens, and the thumbnail at the time of preset registration were stored in association with one another (linked).

However, in this case, an angle of view can be reproduced only for presets in which a focal length within a focal length drive range of a mounted lens is registered. In the Second Embodiment, a method for solving the above problem by using image processing in combination is explained.

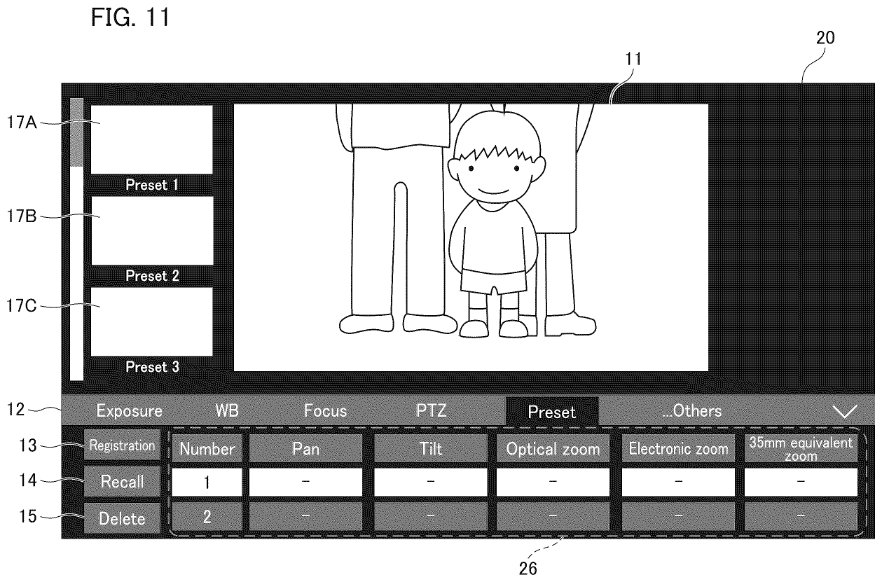

FIG. 10 is a functional block diagram showing a configuration example of an image capturing apparatus of the Second Embodiment. The configuration of the image capturing apparatus in the Second Embodiment differs from the configuration of the First Embodiment in that the configuration includes a cutout unit 301. In addition, a difference is that, whereas the operation screen of the image capturing apparatus in the First Embodiment was a screen as shown in FIG. 2, the operation screen used in the Second Embodiment is a screen as shown in FIG. 11.

In addition, the preset function differs from the First Embodiment in that image cutout processing is used in combination with respect to the preset function. Since other aspects are the same as in the First Embodiment, explanation thereof is omitted. In addition, in the present embodiment, a 35 mm full-size sensor, for example, is mounted on the image capturing unit 200, and explanation is provided on the premise that calculation of angle of view in terms of focal length is performed in 35 mm equivalent.

The image processing unit 300 includes the cutout unit 301, and performs cutout processing of video signals. Electronic zoom is realized by displaying images that underwent image cutout processing on the entire screen.

FIG. 11 is a diagram showing an example of an operation screen of an image capturing apparatus before preset registration in the Second Embodiment. Although information displayed in the preset information display unit 26 of the operation screen 20 of the image capturing apparatus in the Second Embodiment differs from information displayed in the preset information display unit 16 of the First Embodiment shown in FIG. 2, the operation screen 20 is otherwise similar to the operation screen of the First Embodiment.

The preset information display unit 26 is a display unit that displays preset information registered to each preset number. Pan-tilt drive positions (rotation angle positions) from a reference position, optical zoom information that is focal length information of the lens, and electronic zoom information indicating magnification factors by image cutout processing are displayed in the preset information display unit 26. That is, information indicating whether or not electronic zoom by cutout processing is used can be displayed.

In addition, 35 mm equivalent zoom information, that is, the focal length converted to 35 mm equivalent by taking optical zoom and electronic zoom into account, and the like are displayed in the preset information display unit 26.

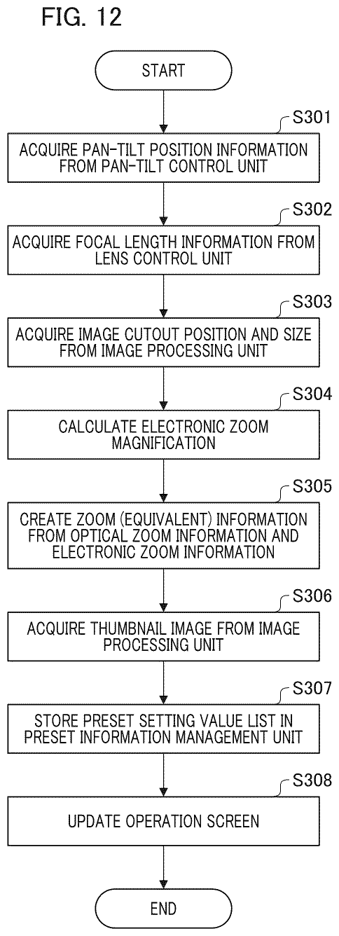

Next, processing at the time of preset registration in the Second Embodiment is explained. When the preset registration button 13 is pressed, registration processing of the preset is initiated according to a flow shown in FIG. 12.

FIG. 12 is a flowchart showing a processing example of preset registration of the Second Embodiment. It should be noted that operations of each step of the flowchart of FIG. 12 are performed sequentially by causing a CPU or the like serving as a computer in the control unit 400 to execute a computer program stored in a memory.

Processing of step S301 and step S302 is similar to step S001 and step S002 of the First Embodiment, and accordingly, an explanation thereof is omitted. In step S303, an image cutout position and size are acquired from the image processing unit.

That is, the control unit 400 issues an image cutout information acquisition request to the image processing unit 300, and the image processing unit 300 acquires information on the image cutout size and position in the cutout unit 301, and returns the information to the control unit 400 as a response to the image cutout information acquisition request.

In step S304, electronic zoom magnification is calculated. That is, the control unit 400 calculates electronic zoom magnification from the image cutout size acquired in step S303. Electronic zoom magnification can be calculated as shown in Equation 1 below, for example.

$$Electronic Zoom Magnification = √ ( {( Horizontal Pixels of Standard Image Size )}^{2} + {( Vertical Pixels of Standard Image Size )}^{2} ) \div √ ( {( Horizontal Pixels of Cutout Image Size )}^{2} + {( Vertical Pixels of Cutout Image Size )}^{2} ) \qquad [ Equation 1 ]$$

Equation 1 described above is used to calculate electronic zoom magnification from the ratio of diagonal lines, in order to make Equation 1 usable even in a case in which image cutout processing is performed on different aspect ratios. However, in a case in which image cutout processing is performed at the same aspect ratio, electronic zoom magnification may be obtained from the ratio of horizontal or vertical pixel numbers. In this manner, the calculation method of electronic zoom magnification can be changed as appropriate, and the calculation method is not limited to Equation 1 described above.

It should be noted that, in the present embodiment, the reference image size is explained as an image size for realizing 35 mm full size. However, the reference image size of the above-described Equation 1 may be any image size such as APS-C size or Micro Four Thirds as a reference image size, according to the size of the sensor to be used.

In addition, a reference image size may be selected from sizes such as APS-C size or Micro Four Thirds using a menu or the like. Then, an image size cut out from a 35 mm full-size sensor corresponding to a selected sensor size may be changed to match the above-described selected reference image size.

In that case, electronic zoom magnification can have a value equal to or less than 1. Furthermore, the reference image size may be changed so that the sensor size becomes a size suitable for the mounted lens.

In step S305, zoom (equivalent) information is created from optical zoom information and electronic zoom information. That is, focal length in 35 mm equivalent is calculated from focal length information of the lens acquired in step S302 and electronic zoom magnification acquired in step S304. For example, in a case in which focal length of the lens is 50 mm and electronic zoom magnification is 2 times, focal length in 35 mm equivalent is calculated as 50 mm×2=100 mm.

In step S306, a thumbnail image is acquired from the image processing unit. That is, the control unit 400 issues a thumbnail image acquisition request to the image processing unit 300. Then, when the image processing unit 300 receives the thumbnail image acquisition request from the control unit 400, the image processing unit 300 creates a thumbnail image from the video signal, and returns a response to the thumbnail image acquisition request to the control unit 400. A thumbnail image created at this time is an image after image cutout processing is performed.

Next, in step S307, a preset setting value list is stored in the preset information management unit. That is, the control unit 400 creates a preset setting value list from information acquired in step S301 to step S306, and stores the preset setting value list in the preset information management unit 800.

Next, in step S308, an operation screen is updated. That is, update of the preset information display unit 16 and the thumbnail display unit 17 of an operation screen of the image capturing apparatus 1 is performed.

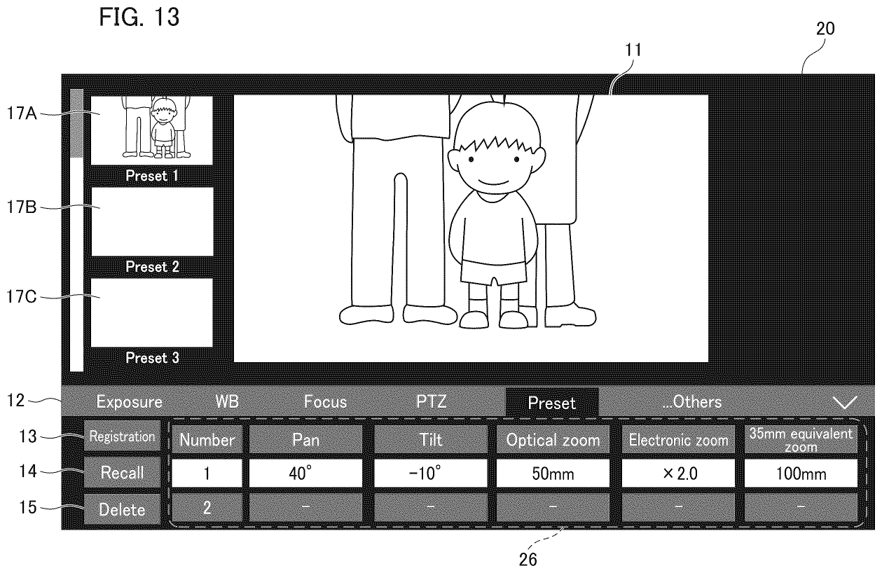

FIG. 13 is a diagram showing an example of an operation screen of the image capturing apparatus after preset registration of the Second Embodiment. In an operation screen after updating, as shown in FIG. 13, preset information stored in the preset setting value list is displayed in the preset information display unit 26. In addition, a thumbnail image created in step S306 is displayed in the thumbnail display unit 17A. When update of the operation screen is completed, the preset registration processing flow of FIG. 12 ends.

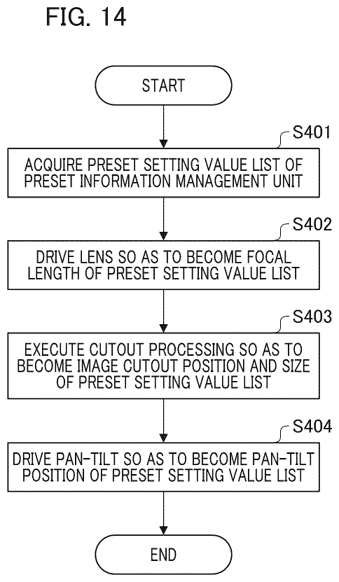

FIG. 14 is a flowchart showing a processing example of preset recall of the Second Embodiment. It should be noted that operations of each step of the flowchart of FIG. 14 are performed sequentially by causing a CPU or the like serving as a computer in the control unit 400 to execute a computer program stored in a memory.

When the preset recall button 14 is pressed, recall processing of the preset is initiated according to the flow shown in FIG. 14. When the preset recall button 14 is pressed and preset recall processing is started, in step S401, a preset setting value list of the preset information management unit is acquired. That is, the control unit 400 acquires a preset setting value list corresponding to a preset number to be recalled from the preset information management unit 800.

Next, in step S402, the lens is driven so that the focal length becomes the focal length of the preset setting value list. That is, the focal length of the lens 2 is driven by a method similar to step S102 of FIG. 5 of the First Embodiment.

Next, in step S403, cutout processing is performed so that the image cutout position and size become the image cutout position and size of the preset setting value list. That is, the control unit 400 issues an image cutout command to the image processing unit 300 so that the image cutout position and size become the image cutout position and size present in the preset setting value list acquired in step S401.

When the image processing unit 300 receives an image cutout command from the control unit 400, the image processing unit 300 performs setting of the cutout unit 301 so that the image cutout position and size become the commanded image cutout position and size, and executes image cutout processing.

Next, in step S404, pan-tilt drive is performed so that the pan-tilt position becomes the pan-tilt position of the preset setting value list. It should be noted that step S404 uses a method similar to step S103 of FIG. 5 of the First Embodiment, and an explanation is omitted. When the processing described above is completed, the preset recall processing flow of FIG. 14 is ended.

Next, processing when lens replacement is performed is explained. In the present embodiment, processing when, after preset registration is performed using a lens having a focal length of 24 mm to 105 mm, the lens is replaced with a lens having a focal length of 24 mm to 70 mm is explained.

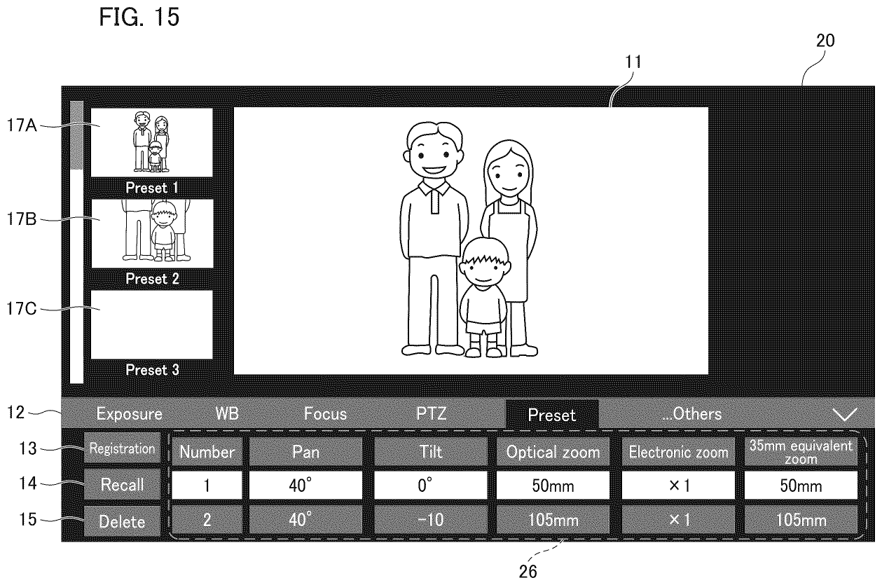

FIG. 15 is a diagram showing an example of an operation screen of an image capturing apparatus before lens replacement in the Second Embodiment. In a state before lens replacement, a lens having a focal length of 24 mm to 105 mm is mounted, and preset registration is performed for preset number 1 and preset number 2.

As shown in FIG. 15, for preset number 1, a pan position of 40°, a tilt position of 0°, an optical zoom of 50 mm, an electronic zoom of ×1, a 35 mm equivalent zoom of 50 mm, and a thumbnail image displayed in the thumbnail display unit 17A are registered as a preset by being associated.

For preset number 2, a pan position of 40°, a tilt position of −10°, an optical zoom of 105 mm, an electronic zoom of ×1, a 35 mm equivalent zoom of 105 mm, and a thumbnail image displayed in the thumbnail display unit 17B are registered as a preset by being associated.

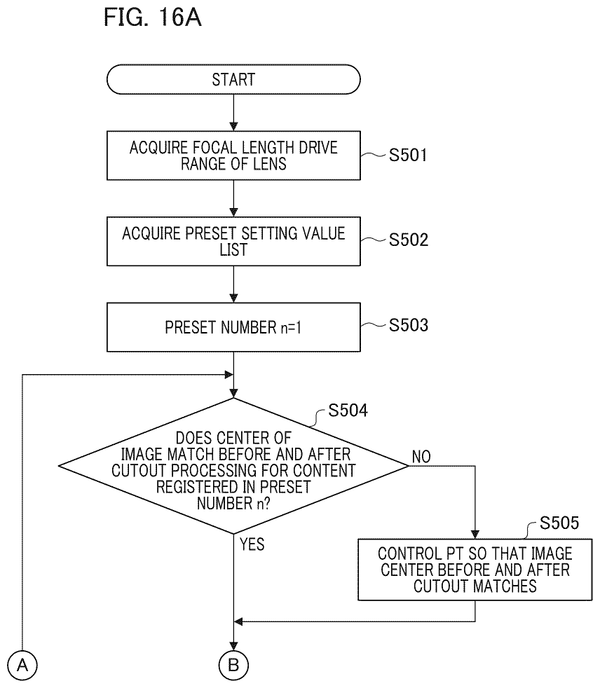

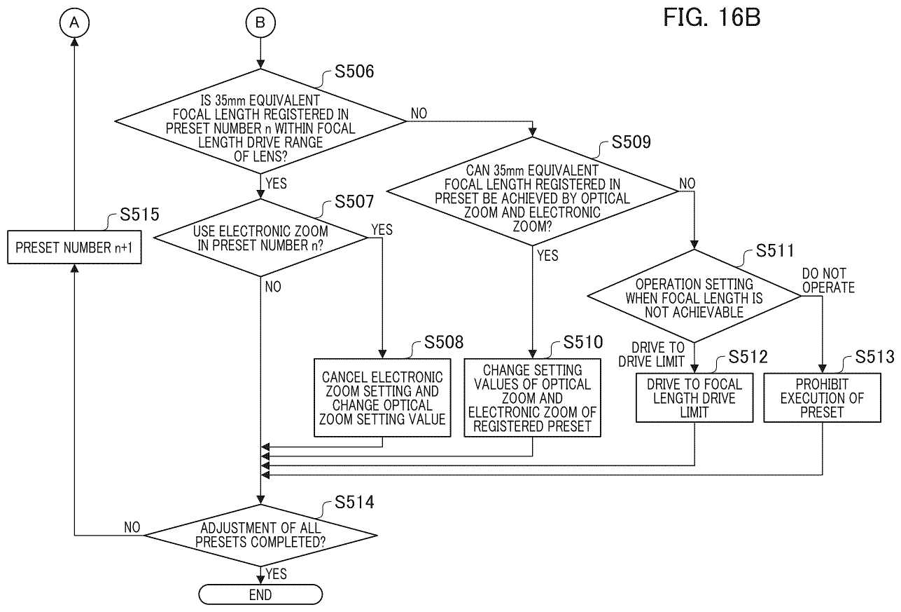

FIG. 16A is a flowchart showing a processing example of update processing of preset information of the Second Embodiment, and FIG. 16B is a flowchart that is a continuation of FIG. 16A.

It should be noted that operations of each step of the flowcharts of FIG. 16A and FIG. 16B are performed sequentially by causing a CPU or the like serving as a computer in the control unit 400 to execute a computer program stored in a memory.

When lens replacement is performed, update processing of preset information is initiated according to a processing flow shown in FIG. 16A. Because processing from step S501 to step S503 is the same as processing from step S201 to step S203 of FIG. 7 of the First Embodiment, an explanation is omitted.

It should be noted that, because optical zoom enlarges and reduces centered on an optical axis, when attempting to correct with optical zoom an image in which the center position of the image has changed before and after image cutout processing, captured video is displaced even if the angle of view is the same.

Accordingly, in the present embodiment, in a case in which the center position of the image has changed due to image cutout processing, processing is performed to align the center of the image by pan-tilt control. The method is explained in step S504 and step S505.

In step S504, a determination is made as to whether or not, for the content registered in preset number n, the center of the image matches before and after cutout processing. That is, the control unit 400 performs determination as to whether or not the center of the image matches before and after image cutout processing from the cutout size and position of the image of electronic zoom information registered in preset number n of a preset setting value list acquired in step S502.

In a case in which the center of the image matches, the processing proceeds to step S506, and in a case in which the center of the image does not match, the processing proceeds to step S505.

In step S505, pan-tilt control is performed so that the centers of the image before and after cutout match. That is, the image capturing direction of the image capturing unit is controlled so that the center of the image cutout position in image cutout processing matches the center of the image. For that purpose, first, the control unit 400 calculates an angle of pan-tilt to be driven so that the centers of the image before and after cutout match.

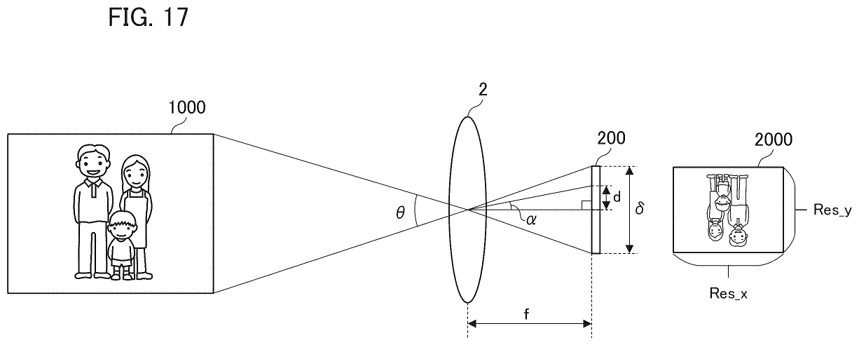

FIG. 17 is a diagram for explaining a relationship among focal length, sensor size, and angle of view. In FIG. 17, an angle of view θ [°] is represented when an object 1000 to be captured forms an image 2000 on the image capturing unit 200 having horizontal resolution Res_x, vertical resolution Res_y, and sensor size δ [mm] by using the lens 2 having focal length f [mm].

At this time, assuming that the center of the image has changed by d [pix] before and after image cutout processing, an angle α [°] to be driven by pan-tilt can be calculated from FIG. 17 using Equation 2 described below.

$$\begin{matrix}( Equation 2 ) & \\ α = {tan}^{- 1} ( \frac{δ \times d}{Res \times f} ) & [ Equation 2 ]\end{matrix}$$

In step S505, the control unit 400 performs calculation of respective drive amounts of pan-tilt from movement amounts d in respective horizontal and vertical directions using Equation 2 described above, and issues pan-tilt drive commands to the pan-tilt control unit 700. Then, pan-tilt drive is performed so as to return the center position of the image changed by image cutout processing to the original position. It should be noted that Equation 2 described above used for pan-tilt drive amount calculation is one example, and a calculation method can be changed as appropriate, such as adding aberration correction of the lens.

In step S506, a determination is made as to whether or not a focal length in 35 mm equivalent registered in preset number n is within a focal length drive range of the lens. That is, the control unit 400 acquires a focal length F35n in 35 mm equivalent registered in preset number n of a preset setting value list acquired in step S502.

From focal length drive range information of the mounted lens 2 acquired in step S501, a focal length Fmin of a wide-angle end and a focal length Fmax of a telephoto end are acquired. In a case in which Fmin≤F35n≤Fmax is established, Yes is determined in step S506 and processing proceeds to step S507, and in a case in which Fmin≤F35n≤Fmax is not established, No is determined in step S506 and processing proceeds to step S509.

In step S507, a determination is made as to whether or not electronic zoom is used in preset number n. That is, a determination is made as to whether or not electronic zoom is used by referencing electronic zoom information registered in preset number n. In a case in which electronic zoom is used, processing proceeds to step S508, and in a case in which electronic zoom is not used, processing proceeds to step S514.

In step S508, release of electronic zoom setting and change of optical zoom setting values are performed. That is, the control unit 400 sets an electronic zoom magnification of a preset setting value list of preset number n to ×1, updates a focal length of the lens of optical zoom information to the same value as a focal length of 35 mm equivalent zoom information, and processing proceeds to step S514.

In this manner, in step S508, in a case in which an angle of view registered by preset registration is realizable by a focal length of a newly mounted lens, preset setting information is updated so that the angle of view is realized using only optical zoom.

In contrast, in step S509, a determination is made as to whether or not a focal length in 35 mm equivalent registered as a preset is realizable using optical zoom and electronic zoom. That is, the control unit 400 determines whether or not a focal length F35n in 35 mm equivalent registered in a preset setting value list of preset number n is realizable using optical zoom and electronic zoom.

Cases in which a focal length F35n in 35 mm equivalent is unrealizable using optical zoom and electronic zoom are, for example, a case in which F35n<Fmin, or a case in which Fmax×(maximum magnification of electronic zoom magnification)<F35n. As a result of the determination, in a case in which the focal length is realizable, processing proceeds to step S510, and in a case in which the focal length is unrealizable, processing proceeds to step S511.

Here, transition to step S511 corresponds to a case in which an angle of view registered by preset registration is unrealizable by a focal length of a newly mounted lens and is unrealizable even by using image cutout processing in combination.

In step S510, setting values of optical zoom and electronic zoom of the registered preset are changed. That is, the control unit 400 performs change of setting values of optical zoom and electronic zoom of the preset registered in preset number n.

That is, in step S510, in a case in which an angle of view registered by preset registration is unrealizable by a focal length of a newly mounted lens, preset setting information is updated so that the angle of view is realized by using optical zoom and image cutout processing in combination.

It should be noted that an optical zoom and an image cutout size for realizing an angle of view registered by preset registration may be individually settable. In addition, a method for determining an optical zoom and an image cutout size for realizing an angle of view registered by preset registration may be switchable.

Although change of each setting value is explained as being performed such that focal length of a lens of optical zoom information=Fmax and electronic zoom magnification=F35n/Fmax, this is one example, and changes may be made using other calculation methods.

In addition, along with change of electronic zoom magnification, update of image cutout position and size registered in preset number n is also performed. When change of various setting values is completed in step S510, processing proceeds to step S514. Processing from step S511 to step S515 is similar to processing from step S205 to step S209 of FIG. 7 of the First Embodiment, and accordingly, an explanation is omitted.

It should be noted that step S512 is processing in a case in which an angle of view registered by preset registration is unrealizable by a focal length of a newly mounted lens and is unrealizable even by using image cutout processing in combination. In addition, in step S512, preset setting information is updated so that the angle of view becomes an angle of view closest to the angle of view registered as a preset.

When adjustment of all presets is completed in step S514, the update processing flow of preset information shown in FIG. 16A and FIG. 16B is ended.

When update processing of preset information as described above is performed, preset information registered in preset number 1 and preset number 2 is updated as described below. That is, a focal length in 35 mm equivalent registered in preset number 1 is 50 mm and is within a focal length drive range of the lens after replacement. In addition, because electronic zoom is not used, update of registered preset information is not performed.

A focal length in 35 mm equivalent registered in preset number 2 is 105 mm and is outside a focal length drive range of the lens after replacement.

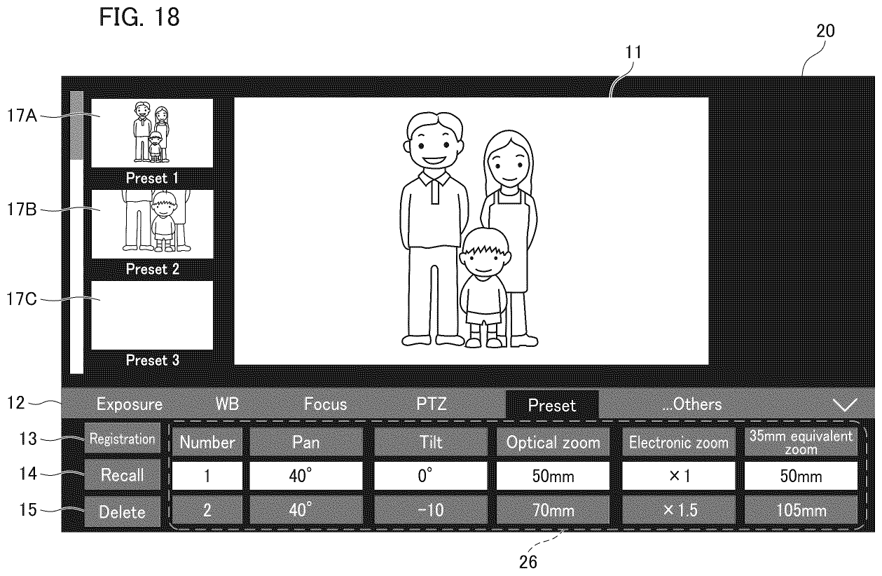

In addition, because a focal length in 35 mm equivalent registered as a preset is realizable using optical zoom and electronic zoom, preset information is updated such that a focal length of optical zoom becomes 70 mm, wherein 70 mm is the focal length of the telephoto end after replacement, and electronic zoom magnification becomes 1.5 times. An operation screen of the image capturing apparatus after update of preset information as described above is updated to an operation screen as shown in FIG. 18.

In this manner, in processing flows of FIG. 16A and FIG. 16B, in a case in which the lens is replaced, update is performed of focal length information stored as preset setting information and of an image cutout size performed by the cutout unit, according to a focal length drive range of a newly mounted lens.

FIG. 18 is a diagram showing an example of an operation screen of an image capturing apparatus after lens replacement of the Second Embodiment. It should be noted that, although the update processing of preset information shown in FIG. 16A and FIG. 16B was performed by prioritizing the lens focal length setting processing of the optical zoom in order to prevent a decrease in resolution, the processing may instead be performed by prioritizing the determination processing of the image cutout size.

That is, whether or not to prioritize retention of image cutout size may be made selectable. In a case in which retention of image cutout size is prioritized, setting of optical zoom may be performed after setting image cutout size at the time of preset registration to a predetermined image cutout size.

In addition, in update processing of preset information shown in FIG. 16A and FIG. 16B, control was performed by driving focal length of the lens to the drive limit, and reducing electronic zoom magnification as much as possible. However, update of setting values of optical zoom information and electronic zoom information may be performed so as to match the lens focal length and electronic zoom magnification at the time of preset registration.

It should be noted that when electronic zoom is used, because the pan-tilt drive unit 600 is not used, immediate switching becomes possible without showing video of a movement process. In order to realize immediate switching, a menu may be prepared for individually registering optical zoom focal length, image cutout position, and size as presets. In addition, options may be provided as to which of these controls to use so as to have the user select a control method.

By performing the processing explained above, an angle of view at the time of preset registration can be reproduced even for presets registered using different lenses.

### Third Embodiment

Hereinafter, a Third Embodiment of the present disclosure is explained. Although explanation was provided with respect to a preset information management method by an image capturing apparatus in the First Embodiment and the Second Embodiment, explanation is provided with respect to a preset information management method by an information processing apparatus in the Third Embodiment.

FIG. 19 is a functional block diagram showing a configuration example of an information processing apparatus of the Third Embodiment. As shown in FIG. 19, the information processing apparatus 3 comprises a control unit 3400, a preset information management unit 3800, and a communication unit 3900, and the information processing apparatus 3 can perform various control operations of the image capturing apparatus 1.

The control unit 3400 has a CPU or the like serving as a computer built therein, and controls operations of respective units of the information processing apparatus and the image capturing apparatus based on a computer program stored in a memory serving as a storage medium.

The preset information management unit 3800 is a recording unit that manages preset information similar to the preset information management unit 800 of the image capturing apparatus 1. The communication unit 3900 is connected to the communication unit 900 of the image capturing apparatus 1, and performs various types of communication with the communication unit 900.

It should be noted that, although in the present embodiment an operation screen of the information processing apparatus 3 is explained as an operation screen common to an operation screen generated by the image capturing apparatus 1, the operation screen may be an operation screen different from the operation screen generated by the image capturing apparatus 1.

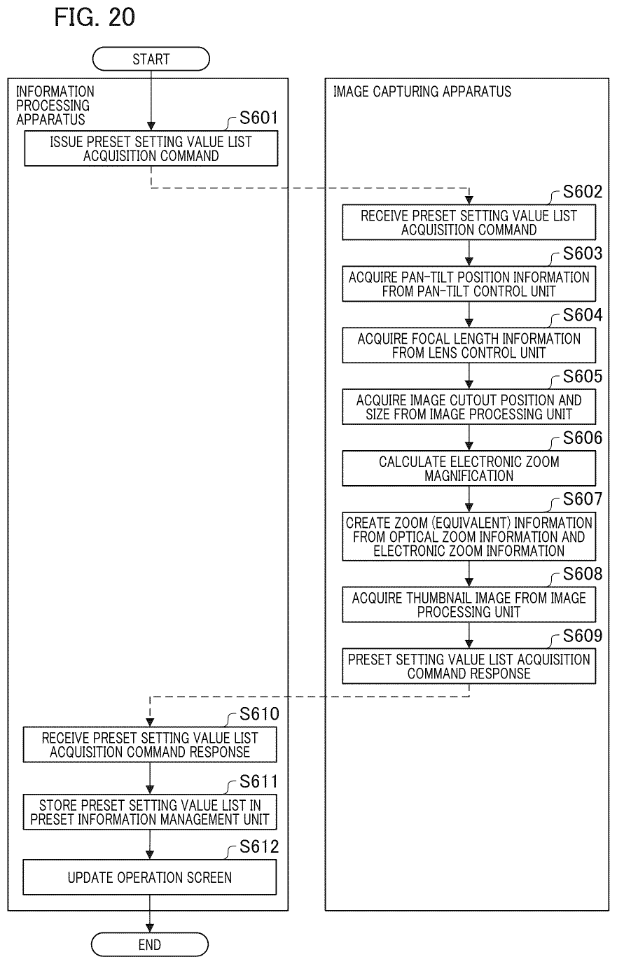

FIG. 20 is a flowchart showing a processing example of preset registration of the Third Embodiment, and preset registration processing is explained based on FIG. 20. It should be noted that operations of each step of the flowchart of FIG. 20 are performed sequentially by causing a CPU or the like serving as a computer in the control unit 400 and respective CPUs or the like serving as computers in the information processing apparatus 3 to execute computer programs stored in respective memories.

Preset registration processing is executed according to a flow shown in FIG. 20. First, in step S601, the control unit 3400 of the information processing apparatus 3 issues a preset setting value list acquisition command to the image capturing apparatus 1 via the communication unit 3900.

In step S602, the image capturing apparatus 1 receives a preset setting value list acquisition command via the communication unit 900. When the preset setting value list acquisition command is received, the control unit 400 executes processing described in step S603 to step S608, and initiates acquisition of various types of information related to a preset setting value list.

Processing of step S603 to step S608 is the same as processing of step S301 to step S306 of the Second Embodiment, and accordingly, an explanation thereof is omitted. Next, in step S609, the control unit 400 creates a preset setting value list from information acquired in step S603 to step S608, and returns the preset setting value list to the information processing apparatus 3 via the communication unit 900 as a response to the preset setting value list acquisition command.

In step S610, the information processing apparatus 3 receives a response to the preset setting value list acquisition command from the image capturing apparatus 1 via the communication unit 3900. In step S611, the control unit 3400 stores a response result of the preset setting value list acquisition command received by the control unit 3400 in the preset information management unit 3800.

In this manner, in step S611, focal length information of a lens mounted on the image capturing apparatus, acquired by the communication unit 3900, and thumbnails based on images captured by the image capturing apparatus using the focal length of the lens are stored in association with each other by the preset information management unit 3800. Here, step S611 functions as a preset information management step.

Finally, in step S612, the control unit 3400 performs update of an operation screen according to a preset setting value list stored in the preset information management unit 3800. By performing processing as described above, when update of the operation screen is completed, registration processing of the preset is ended.

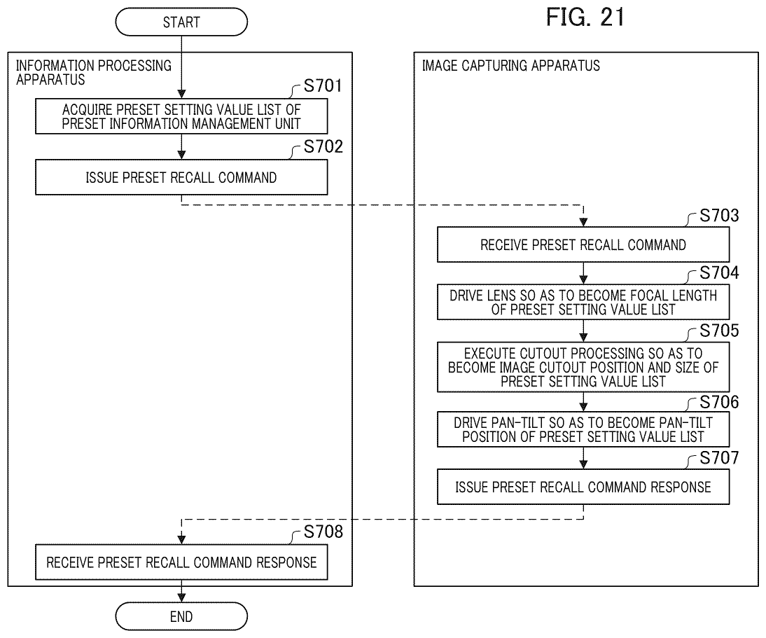

FIG. 21 is a flowchart showing a processing example of preset recall of the Third Embodiment. It should be noted that operations of each step of the flowchart of FIG. 21 are performed sequentially by causing a CPU or the like serving as a computer in the control unit 400 and respective CPUs or the like serving as computers in the information processing apparatus 3 to execute computer programs stored in respective memories.

Preset recall processing is executed according to the flow shown in FIG. 21. First, in step S701, the control unit 3400 of the information processing apparatus 3 acquires a preset setting value list stored in the preset information management unit 3800.

Next, in step S702, a preset recall command is created according to content of the preset setting value list acquired in step S701, and the preset recall command is issued to the image capturing apparatus 1 via the communication unit 3900. In step S703, the image capturing apparatus 1 receives the preset recall command via the communication unit 900.

When the preset recall command is received, the control unit 400 executes processing described in step S704 to step S706, and initiates preset recall. Processing of step S704 to step S706 is the same as processing of step S402 to step S404 of the Second Embodiment, and accordingly, an explanation thereof is omitted.

When preset recall is completed, a response to the preset recall command is created in step S707, and the response is returned to the information processing apparatus 3 via the communication unit 900. When the information processing apparatus 3 receives the response to the preset recall command in step S708, recall processing of the preset is ended.

Next, update processing of preset information when a lens is replaced in the Third Embodiment is explained. When a lens of the image capturing apparatus 1 is replaced, the lens control unit 500 detects, via the lens connection unit 100, that the lens 2 has been connected, and acquires a focal length drive range of the lens 2 by processing similar to step S201. Then, the lens control unit 500 creates a lens replacement detection notification including the acquired focal length drive range of the lens 2, and issues (transmits) the lens replacement detection notification to the information processing apparatus 3.

When the information processing apparatus 3 receives the lens replacement detection notification, the information processing apparatus 3 updates a preset setting value list stored in the preset information management unit 3800. An update method of the preset setting value list is similar to processing flows of the Second Embodiment shown in FIG. 16A and FIG. 16B. That is, except for a thumbnail image acquisition method performed in processing of step S512, the update method is a method similar to step S502 to step S515 of the Second Embodiment, and accordingly, an explanation thereof is omitted.

A thumbnail image acquisition method performed in processing of step S512 in the Third Embodiment is a method in which the control unit 3400 of the information processing apparatus 3 creates a thumbnail image update request, and transmits the thumbnail image update request to the image capturing apparatus 1.

The image capturing apparatus acquires a thumbnail image registered in a target preset setting value list, and returns the thumbnail image to the information processing apparatus 3 as a response to the thumbnail image update request. The information processing apparatus 3 performs update of a corresponding preset setting value list by using the received thumbnail image.

In this manner, in a case in which the control unit 3400 of the information processing apparatus 3 detects, via the communication unit, that a lens has been replaced, the control unit 3400 performs update of focal length information stored in the preset information management unit 3800 according to a focal length drive range of a lens newly mounted on the image capturing apparatus.

It should be noted that a thumbnail image acquisition method is not limited to the method described above, and re-acquisition of thumbnail images may be performed by executing preset recall processing. That is, in a case in which an angle of view registered by preset registration is unrealizable by a focal length of a newly mounted lens and is unrealizable even by using image cutout processing in combination, thumbnails may be re-acquired.

Alternatively, update of thumbnails may not be performed during update processing sequences of the preset information described above, and update may be performed at arbitrary timing. In that case, because a thumbnail image differs from an angle of view at the time of preset execution, identification information such as icons may be presented. That is, in a case in which a thumbnail having an angle of view different from that at the time of preset registration is displayed, predetermined identification information (characters, icons, and the like) may be displayed.

By performing processing as described above, even in a case in which a lens of the image capturing apparatus 1 is replaced, update of a preset setting value list of the information processing apparatus 3 can be performed in a timely manner. In addition, by performing processing described above, an angle of view at the time of preset registration can be reproduced even for presets registered using different lenses.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image capturing apparatus and the like through a network or various storage media. Then, a computer (or a CPU, an MPU, or the like) of the image capturing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2024-187730, filed on Oct. 24, 2024, which is hereby incorporated by reference herein in its entirety.

What is claimed is:

1. An image capturing apparatus comprising:
an image capturing unit configured to capture an image via a lens;
one or more memories storing instructions; and
one or more processors executing the instructions to:
control an image capturing direction of the image capturing unit;
when registering a preset of the image capturing direction, create a thumbnail based on an image captured by the image capturing unit, and store, as preset setting information, the thumbnail, the image capturing direction, and focal length information of the lens, by associating the thumbnail, the image capturing direction, and the focal length information; and
in a case in which the lens is replaced, perform update of the focal length information in the preset setting information according to a focal length drive range of a newly mounted lens.

2. The image capturing apparatus according to claim 1, wherein the one or more processors further execute the instructions to:
perform cutout processing of the image; and
in a case in which the lens is replaced, perform update of the focal length information and an image cutout size that are stored as the preset setting information according to a focal length drive range of a newly mounted lens.

3. The image capturing apparatus according to claim 1, wherein the one or more processors further execute the instructions to:
in a case in which an angle of view registered by the preset registration is realizable at a focal length of a newly mounted lens, update the preset setting information such that the angle of view is realized using only optical zoom.

4. The image capturing apparatus according to claim 1, wherein the one or more processors further execute the instructions to:
in a case in which an angle of view registered by the preset registration is not realizable at a focal length of a newly mounted lens, update the preset setting information such that the angle of view is realized by combined use of optical zoom and image cutout processing.

5. The image capturing apparatus according to claim 4, wherein whether to prioritize retention of an image cutout size is selectable; and
wherein the one or more processors further execute the instructions to:
in a case in which retention of the image cutout size is prioritized, after setting the image cutout size at the time of the preset registration to a predetermined image cutout size, perform setting of optical zoom.

6. The image capturing apparatus according to claim 1, wherein the one or more processors further execute the instructions to: in a case in which an angle of view registered by the preset registration is not realizable at a focal length of a newly mounted lens and is not realizable even by combined use including image cutout processing, restrict execution of a preset.

7. The image capturing apparatus according to claim 1, wherein the one or more processors further execute the instructions to:
in a case in which an angle of view registered by the preset registration is not realizable at a focal length of a newly mounted lens and is not realizable even by combined use including image cutout processing, update the preset setting information such that an angle of view closest to the angle of view registered by the preset registration is realized.

8. The image capturing apparatus according to claim 1, wherein the one or more processors further execute the instructions to:
in a case in which an angle of view registered by the preset registration is not realizable at a focal length of a newly mounted lens and is not realizable even by combined use including image cutout processing, reacquire the thumbnail.

9. The image capturing apparatus according to claim 1, wherein, for realizing an angle of view registered by the preset registration, optical zoom and an image cutout size are individually settable.

10. The image capturing apparatus according to claim 9, wherein, for realizing an angle of view registered by the preset registration, determination methods for the optical zoom and the image cutout size are switchable.

11. The image capturing apparatus according to claim 1, wherein one or more memories store instructions; and one or more processors execute the instructions to:
perform cutout processing of the image; and
enable display of information indicating whether or not electronic zoom by the cutout processing is being used.

12. The image capturing apparatus according to claim 1, wherein the one or more processors further execute the instructions to:
display predetermined identification information in a case in which a thumbnail having an angle of view different from that at the time of the preset registration is being displayed.

13. The image capturing apparatus according to claim 1, wherein the one or more processors further execute the instructions to:
control at least one of a pan direction and a tilt direction.

14. The image capturing apparatus according to claim 1, wherein the one or more processors further execute the instructions to:
control an image capturing direction of the image capturing unit such that the center of an image cutout position in an image cutout processing coincides with the center of the image.

15. An information processing apparatus comprising:
one or more memories storing instructions; and
one or more processors executing the instructions to:
perform communication;
store, by associating, focal length information of a lens mounted on an image capturing apparatus that is acquired via the communication, and a thumbnail based on an image captured by the image capturing apparatus at a focal length of the lens; and
in a case in which replacement of the lens is detected via the communication, perform update of the focal length information already stored according to a focal length drive range of a lens newly mounted on the image capturing apparatus.

16. An image capturing method comprising:
controlling an image capturing direction of an image capturing unit that captures an image via a lens;
when registering a preset of the image capturing direction, creating a thumbnail based on an image captured by the image capturing unit, and storing, as preset setting information, the thumbnail, the image capturing direction, and focal length information of the lens, by associating the thumbnail, the image capturing direction, and the focal length information; and
in a case in which the lens is replaced, performing update of the focal length information in the preset setting information according to a focal length drive range of a newly mounted lens.

17. A non-transitory computer-readable storage medium storing a computer program including instructions for executing the following processes:
controlling an image capturing direction of an image capturing unit that captures an image via a lens;
when registering a preset of the image capturing direction, creating a thumbnail based on an image captured by the image capturing unit, and storing, as preset setting information, the thumbnail, the image capturing direction, and focal length information of the lens, by associating the thumbnail, the image capturing direction, and the focal length information; and
in a case in which the lens is replaced, performing update of the focal length information in the preset setting information according to a focal length drive range of a newly mounted lens.
